(19) United States
(12) Patent Application Publication
(10) Pub. No.: US 2015/0072111 A1
(43) Pub. Date: Mar. 12, 2015

(54) METHOD FOR MANUFACTURING A FLOOR COVERING

(71) Applicant: METHOD FOR MANUFACTURING A FLOOR COVERING, Weinheim (DE)

(72) Inventors: Dieter Rischer, Abtsteinach (DE); Mario Kroeger, Bruchsal (DE)

(21) Appl. No.: 14/385,569

(22) PCT Filed: Mar. 18, 2013
(86) PCT No.: PCT/EP2013/000814

§ 371 Date: Sep. 16, 2014

(30) Foreign Application Priority Data
Mar. 19, 2012 (DE) 102012005312.6

(51) Int. Cl. E04F 15/16; D06N 1/00; B29D 99/00

(52) U.S. Cl. CPC E04F 15/163; B29D 99/0057; D06N 1/00; B29L 2031/732
USPC 428/195.1; 264/293; 264/160

(57) ABSTRACT

Method for manufacturing a floor covering in which first the material of the layer is provided, said material being transferred to a sheet-shaped mould forming the layer and then fed to a device for vulcanisation, wherein the device comprises a roller arrangement with rollers, wherein a separating layer is provided between roller and layer, and wherein the separating layer is provided with a transmission structure, said transmission structure being transferred to the layer while the layer is running through the device, as a result of which the structure with zones of a different gloss level is formed on the layer, said invention further relating to a floor covering manufactured in this way.

The invention relates to a method for manufacturing a floor covering, including at least one layer that is substantially in the form of a web or sheet and is provided on at least one surface with a visually perceptible pattern, and a floor covering manufactured in this manner.

DE 39 42 505 C1 discloses applying an embossed texture to a surface of a floor covering. The embossed texture is applied to the surface of a floor covering during the original formation of the floor covering, in particular during a calendering procedure. For this purpose, the material of the floor covering is guided through a roller arrangement, wherein either the surfaces of the rollers are provided with an embossed pattern or, between the roller and the material a paper, for example a separating paper is located, which is provided with the embossed pattern. During the passage through the roller arrangement, the embossed pattern is transferred from the roller or the paper to the material and hence to the surface of the floor covering. Here, the embossed pattern is of macroscopic construction, with the result that a relief-type texture is formed on the floor covering. In the case of a frequently used embossed pattern, for example a surface resembling flagstones is formed on the surface of the floor covering.

Such kind of embossed texture is disadvantageous because of the macroscopic texture that involves a disadvantageous soiling resistance with respect to collecting dirt and impairs the capacity for cleaning by comparison with smooth floor coverings.

The object of the invention is to provide a floor covering which, despite having an imperceptible texturing, is provided with a visually perceptible pattern.

This object is achieved by the features of claim 1 and claim 7. The subclaims refer to advantageous embodiments.

In the method according to the invention for manufacturing a floor covering in the form of a web or sheet, the material of the layer is first provided and converted by means of a calender into a web form that forms the layer, and is then fed to a device for the purpose of vulcanization, wherein the device includes a roller arrangement with rollers, and wherein a separating film is provided between the roller and the layer, and wherein the separating film is provided with a transfer pattern, and wherein the layer having the transfer pattern is pressed against the layer during passage of the layer through the device, as a result of which a visually perceptible pattern having the zones of different levels of gloss is formed on the layer.

According to the invention, the pattern having the zones of different levels of gloss is transferred to the floor covering without applying an additional layer to the floor covering. The method makes it possible to manufacture continuously a floor covering that is provided with a microscopic pattern. Further, the texturing is integrated in the method step of combined heat and pressure treatment that is required for manufacturing a floor covering made from rubbery-elastic material, with the result that moreover no additional method steps are made necessary.

At least one roller may be covered with a separating film on the side that faces the layer, wherein the separating film is provided with the pattern. Here, the separating film preferably takes the form of a separating paper. In other embodiments, it is also conceivable for the separating film to be made from a metal foil. In this embodiment, it is advantageous that it is not the high-cost roll that is provided with the pattern but the comparatively inexpensive separating paper. Moreover, it is advantageous that it is possible to change the pattern without having to replace the roller. It is possible to construct the separating film both for use multiple times and for only one-time use.

The separating film may be provided with a coating which forms zones of the transfer pattern. Here, the coating preferably takes the form of a layer of paint. According to the invention, the layer of paint is constructed such that it remains on the separating film and only transfers its micro-texture to the floor covering. Surprisingly, it has been found that the paint transferred to the separating film is sufficiently stable for it on the one hand not to come off the separating film, and on the other hand the paint is also dimensionally stable in order to transfer its micro-texture to the floor covering and there to form a visually perceptible pattern. It is also conceivable for further zones to be formed directly from the untreated surface of the separating film.

The texture that is transferred to the material in web form is microscopic and has a depth of at most 30 μm, preferably at most 10 μm. As a result, the pattern imparted to the material in web form differs from known embossed textures, which are macroscopic and have a substantially greater depth, so project substantially more deeply into the material in web form.

For forming the transfer pattern, the layer of paint may include zones of a first paint having a first level of gloss, and zones of a second paint having a second level of gloss. Here, preferably the first paint takes the form of a gloss paint which has on the one hand a low surface roughness and on the other at least a silk gloss texture. The second paint preferably takes the form of a matt paint which has on the one hand a higher surface roughness than the gloss paint and on the other at most a silk matt texture. So that the surface can be given a texture in the form of a pattern, first a first layer of paint is applied over the full surface of the separating film, and once the first layer of paint, which may take either a matt or a gloss form, has dried the second layer of paint is applied to certain zones of the first layer of paint, with the result that the visually perceptible pattern is produced.

The floor covering according to the invention includes at least one layer in web or sheet form, which is provided on at least one surface with a visually perceptible pattern, wherein the pattern has zones of different levels of gloss.

In the case of the macroscopic embossing which is known from the prior art, a relief-type surface texture is indeed produced, but the optical reflection is identical in each portion of the surface, apart from the perpendicular edges of the surface texture. This uniform optical reflection results from the fact that the microscopic surface texture of the separating paper remains unchanged, whereas a pattern is embossed in the separating paper. Accordingly, the embossing has the effect that the two-dimensional separating paper is transferred to a three-dimensional texture without the surface texture of the separating paper being changed. In contrast to this known construction, in the case of the floor covering according to the invention a change is brought about in the microscopic texture, which for the reasons mentioned above cannot be achieved solely by a macroscopic embossing of the separating paper or the roller. The floor covering according to the invention is provided with a pattern caused by microscopic effects. In this case, according to the invention no macroscopic texturing of the floor covering is provided, but this can still be imparted to the floor covering in addition, for example by an additional processing step. Overall, the embossing produces a three-dimensional pattern which is also perceived as such. In contrast to this, in the case of the construction according to the invention the pattern is not perceived as three-dimensional. Perception of the pattern is the result of the different levels of gloss.

The microscopic surface texture is imparted directly to the material in web form, and penetrates into the material by at most 30 μm, preferably at most 10 μm. In contrast to this, the known textures from embossing penetrate by at least 0.1 mm and so penetrate substantially more deeply into the material.

The floor covering according to the invention has zones of different levels of gloss. Gloss is characterized by a directional reflection of incident light, and is also called specular reflection. In accordance with DIN 67530/ISO 2813, the level of gloss may be determined by measurement using a reflectometer. A reflectometer emits a beam of light at a predetermined angle of incidence onto the surface for testing, and receives the beam of light reflected by the surface. The ratio of light intensity between the emitted and the received beams of light characterizes the level of gloss of a surface. The level of gloss is categorized into steps ranging from high gloss (20° angle of incidence, 60% to 70% reflection) through glossy (60°, 55% to 65%), silk gloss (60°, 25% to 35%), silk matt (85°, 40% to 50%) to matt (85°, 6% to 8%).

Preferably, first zones are made more glossy than second zones. In this arrangement, in a first embodiment, first zones may be made at least silk gloss and second zones may be made at most silk matt. In accordance with DIN 67530/ISO 2813, a silk gloss layer has a level of reflection of 25% to 35% at a measurement angle of 60°, and a silk matt layer has a level of reflection of 40% to 50% at a measurement angle of 85°. Here, the surface of the floor covering is textured such that a significant proportion of the light falling on the floor covering is reflected by the floor covering in directional manner. Those surfaces which have a diffuse reflection behavior are referred to as matt. Here, reflection of the incident light is not directional but non-directional. Preferably, the zones are in this case arranged on the floor covering in the form of a pattern. For example, it is conceivable to arrange strips of gloss texture and strips of matt texture next to one another. According to the invention, the first zone may be made silk gloss, glossy or high gloss, and the second zone may be made silk matt or matt. In a further embodiment, it is also conceivable for the second zone to have a level of gloss that is at least one step below the level of gloss of the first zone.

The first zone and the second zone may have mutually deviating roughness values. The first zone, of gloss texture, here preferably has an average roughness Rₐ of between 1 μm and 2.5 μm (EN ISO 25178) and the second zone, of matt texture, preferably has a roughness Rₐ of between 3 μm and 5 μm (EN ISO 25178). In an embodiment of this kind, it is advantageous that the floor covering may be provided with a pattern that is (microscopically) visually perceptible without the macroscopic texture of the surface of the floor covering being changed. This significantly improves the cleaning behavior of the floor covering. In a situation where there is a need to travel over the floor with vehicles, for example industrial trucks, it is in particular advantageous if the floor can be provided with a pattern but has no relief texture. Overall, the depth of penetration of the visually perceptible pattern is at most 30 μm, preferably at most 10 μm. As a result, it is possible for vehicles of all kinds to travel over the floor covering according to the invention without problems, and for the zones of different levels of gloss not to be felt even when walking, in contrast to a macroscopic relief pattern.

The layer may include an elastomer material. The elastomer material may in this case be formed by a thermoplastic elastomer or a rubber. Floor coverings made from materials of this kind have advantageous properties in use, such as being non-slip and sound-absorbent to footfall, and having low electrostatic charge build-up. Moreover, the polymers may be selected such that the floor covering furthermore has an advantageous, in particular low-emission, behavior in the event of fire. Advantageous materials for the matrix of the floor covering are nitrile-butadiene rubber (NBR), styrene-butadiene rubber (SBR), butadiene rubber (BR), ethylene-propylene-diene rubber (EPDM), natural rubber (NR), ethylene vinyl acetate (EVA) and/or isoprene rubber (IR).

The at least one surface may directly form the surface of the floor covering that faces the room, wherein the texture is preferably imparted directly to the layer. It is already known in the technical field of laminate flooring to apply to the laminate a transfer paper provided with a pattern, and to connect it fixedly thereto. In the case of the floor covering according to the invention, by contrast, the pattern is imparted directly to the surface of the single layer of material in web form, with the result that it is conceivable for the floor covering to be formed by only a single layer from the surface whereof the micro-texture according to the invention is constructed. In another embodiment, the floor covering may have a plurality of layers of elastomer and/or rubbery-elastic material. In all cases, however, the visually perceptible pattern is imparted to an elastomer material.

Some embodiments of the floor covering according to the invention will be explained in more detail below with reference to the figures. These show in a schematic manner:

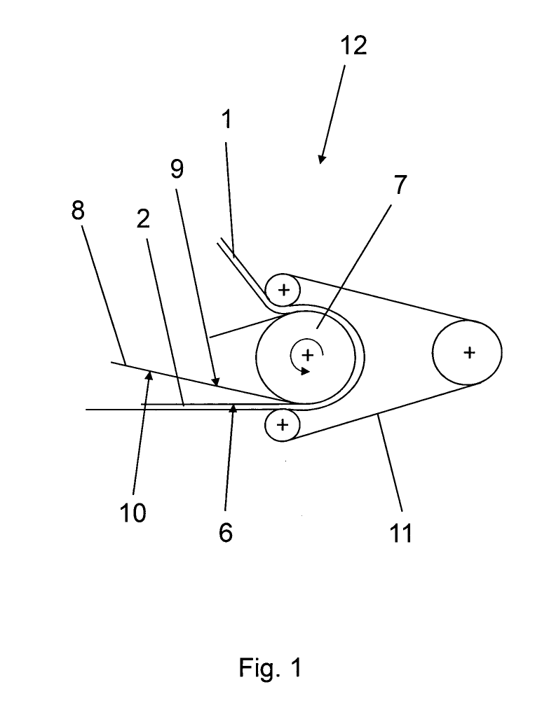

In FIG. 1, the method of manufacturing the floor covering; and

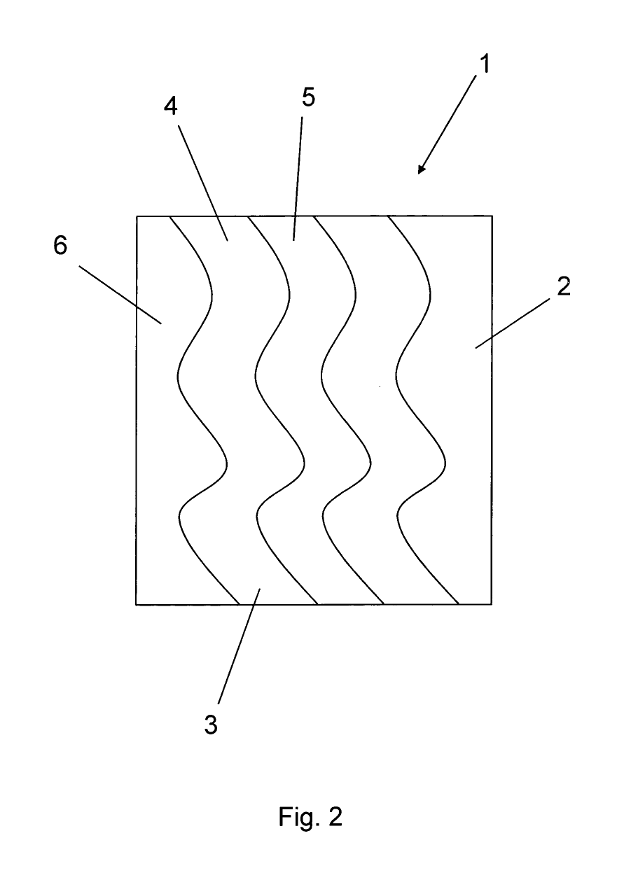

In FIG. 2, the floor covering.

FIG. 1 shows a device for manufacturing a floor covering 1 having a visually perceptible microscopic pattern. Here, first the material of the layer 2 is first and provided the layer 2 is first provided and converted to a web form that forms the layer 2. For this purpose, the raw material, for example the raw material NBR, is mixed in a kneader, and the resulting raw mass is fed to a calender whereof the roller arrangement rolls out the raw mass into a web. Further, air bubbles that are included during the calendering are expelled from the material. This material in web form is fed to a device 12 for the purpose of vulcanization, that is to say for curing the elastomer material. The device 12 may be constructed for continuous or discontinuous vulcanization, wherein in the present case continuous vulcanization is performed in a device 12 that takes the form of a web vulcanization plant.

For continuous vulcanization, the web vulcanization plant includes a heatable roller 7 around which a clampable steel band 11 is guided over part of a circle. The steel band 11 is guided on rolls and runs around with the heatable roller 7. For vulcanization, the material in web form is introduced into the gap between the steel band 11 and the roller, is guided continuously around the roller 7 and is then removed. The web vulcanization plant is set up such that the material in web form remains in the plant for five minutes, wherein the curing temperature is 180° C. The vulcanization has the effect of curing the material and producing the rubbery-elastic properties. A separating film 8 made from a paper is arranged between the roller 7 and the material in web form. This separating film 8 is unrolled from a roll, is introduced into the gap between the roller 7 and the steel band 11, and runs around the roller 7 together therewith. The separating film 8 is positioned in the gap such that it bears against the roller 7 and so prevents direct contact between the material in web form and the roller 7. The separating film 8 has a transfer texture 10, wherein, as the material in web form passes through the roller 7, the separating film 8 with the transfer texture 10 is pressed against the material in web form, as a result of which ultimately the texture 3 is formed on the layer 2 produced from the material in web form. The separating film 8 is provided with a layer of paint 9. The layer of paint 9 is arranged on the side of the separating film 8 that faces the material in web form. The layer of paint forms the transfer texture 10, wherein, for the purpose of forming the transfer texture 10, the layer of paint 9 includes zones 4 of a first paint having a first level of gloss, namely silk gloss, and zones 5 of a second paint having a second level of gloss, namely silk matt.

The layer 2 in web form can then be cut into sections in sheet form.

In another embodiment, only a first zone 4 is formed by the paint, while a second zone 5 is formed directly by the untreated surface of the separating film 8, that is to say the paper.

The separating film 8 is coated by an application of the first paint over its full surface and then an application of the second paint, wherein the second paint is not applied over the full surface but is applied such that zones 4, 5 of different levels of gloss are formed on the separating film 8, as a result of which the transfer pattern 10 is once again formed.

FIG. 2 shows a floor covering 1, including at least one layer 2 in web or sheet form, made from an elastomer material, in this embodiment NBR. The floor covering 1 has two main sides, wherein one surface faces the floor and one surface faces the room. The surface that faces the room is provided with a visually perceptible pattern 3, wherein the pattern 3 has zones 4, 5 of different levels of gloss. The pattern 3 is imparted directly to the layer 2 such that the floor covering 1 overall comprises only a single layer 2. The first zone 4 is made to be silk gloss and the second zone 5 is made to be silk matt. This difference in the levels of gloss results from mutually deviating roughness values between the first and the second zone.

### Exemplary Embodiments

The level of gloss in the exemplary embodiments below is determined in accordance with DIN 67530/ISO 2813 using a reflectometer, and the average roughness is determined without contact by white light interferometry in accordance with EN ISO 25178.

### First Sample

The first sample is a black floor covering which is provided with a pattern 3 as described above. The floor covering has a pattern 3 with first zones 4 and second zones 5, wherein the first zones 4 are more glossy than the second zones 5:

### Level of Gloss

| Glossy zones | | Matt zones | |
|---|---|---|---|
| Angle of incidence | | Angle of incidence | |
| 60° | 85° | 60° | 85° |
| 26% | 40% | 11% | 13% |

### Average Roughness Rₐ

Glossy zones: 2.3 μm
Matt zones: 4.4 μm

### Second Sample

The second sample is a beige floor covering which is provided with a pattern 3 as described above. The floor covering has a pattern 3 with first zones 4 and second zones 5, wherein the first zones 4 are more glossy than the second zones 5:

### Level of Gloss

| Glossy zones | | Matt zones | |
|---|---|---|---|
| Angle of incidence | | Angle of incidence | |
| 60° | 85° | 60° | 85° |
| 35% | 50% | 14% | 16% |

### Average Roughness Rₐ

Glossy zones: 1.4 μm
Matt zones: 3.5 μm

1. A method for manufacturing a floor covering made from an elastomer material, in which the material of the layer is first provided and, which is converted into a web form that forms the layer, and is then fed to a device for the purpose of vulcanization, wherein the device includes a roller, wherein a separating film is provided between the roller and the layer, and wherein the separating film is provided with a transfer pattern, and wherein the separating film having the transfer pattern is pressed against the layer during passage of the layer through the device, as a result of which a visually perceptible pattern having zones of different levels of gloss is formed on the layer.

2. The method as claimed one of claims 2, wherein the separating film is provided with a coating which forms zones of the transfer pattern.

3. The method as claimed in claim 2, wherein the coating of the separating film is formed by a paint.

4. The method as claimed in claim 2,
wherein the coating for forming the transfer pattern includes zones of a paint having a first level of gloss, and zones of a paint having a second level of gloss.

5. The method as claimed in claim 1, wherein, following the vulcanization, the layer in web form is cut into sections in sheet form.

6. A floor covering, including at least one layer in web or sheet form, which is provided on at least one surface with a visually perceptible pattern, characterized in that the pattern has zones of different levels of gloss.

7. The floor covering as claimed in claim 6, wherein first zones are made more glossy than second zones.

8. The floor covering as claimed in claim 6, wherein the first zone and the second zone have mutually deviating roughness values.

9. The floor covering as claimed in claim 6, wherein the layer includes an elastomer material.

10. The floor covering as claimed in claim 6, wherein the at least one surface forms the surface of the floor covering that faces the room.

11. The floor covering as claimed in claim 6, wherein the pattern is preferably imparted directly to the layer.
